(19) United States
(12) Patent Application Publication
(10) Pub. No.: US 2026/0145259 A1
(43) Pub. Date: May 28, 2026

(54) WELD ELECTRODE WITH IMPROVED COOLING

(71) Applicant: GM Global Technology Operations LLC, Detroit, MI (US)

(72) Inventors: Robert W. Watson, China, MI (US); Zhenke Teng, Troy, MI (US); Mitra Shabani, Royal Oak, MI (US); Ante Tony Lausic, Burlington (CA); Russell A. Webster, Marine City, MI (US); Jerome Longtine, Marine City, MI (US)

(21) Appl. No.: 18/958,431

(22) Filed: Nov. 25, 2024

(51) Int. Cl. B23K 11/30; B23K 11/11

(52) U.S. Cl. CPC B23K 11/3054; B23K 11/11

(57) ABSTRACT

An electrode of a resistance spot welding apparatus includes a base portion, a tip portion and a tapered portion positioned between and connecting the base portion and the tip portion. A cooling channel is formed internal to the electrode to convey a flow of cooling fluid therethrough. The cooling channel includes at least one channel turn portion where the cooling channel turns 180 degrees between a channel inlet and a channel outlet.

The subject disclosure relates to resistance spot welding, and in particular to apparatus for performing such welding on vehicle body flanges.

Resistance spot welding in the automotive industry is typically performed on flanges of the vehicle body having a width of nine millimeters or greater. Thus if welding is necessary for structural integrity of a particular portion of the vehicle body, flanges of the body panel at the particular location have a designed width of 9 millimeters or greater. Welding at smaller flanges presents multiple challenges, which include increased heat density in the weld area resulting in expulsion, reduced electrode cooling due to smaller weld electrodes preventing sufficient cooling water flow, and rapid electrode degradation.

### SUMMARY

In one exemplary embodiment, an electrode of a resistance spot welding apparatus includes a base portion, a tip portion and a tapered portion positioned between and connecting the base portion and the tip portion. A cooling channel is formed internal to the electrode to convey a flow of cooling fluid therethrough. The cooling channel includes at least one channel turn portion where the cooling channel turns 180 degrees between a channel inlet and a channel outlet.

In addition to one or more of the features described herein, the electrode includes a base recess formed in the base portion and the channel inlet and the channel outlet are formed in a recess wall of the base recess.

In addition to one or more of the features described herein, a first channel portion of the cooling channel extends from the channel inlet to the channel turn portion, at least one second channel portion extends from the channel turn portion to one or more channel outlets.

In addition to one or more of the features described herein, a length of the cooling channel from the channel inlet to the channel turn portion is in a range of 5 to 15 millimeters.

In addition to one or more of the features described herein, a radius of curvature of the channel turn portion is in a range of 5 to 15 millimeters.

In addition to one or more of the features described herein, a diameter of the cooling channel is in a range of 1 to 2.5 millimeters.

In addition to one or more of the features described herein, the electrode is formed from a cooper material via one or more additive manufacturing processes and a post-forming heat treatment.

In another exemplary embodiment, a method of producing an electrode of a resistance spot welding apparatus includes forming an electrode including a base portion, a tip portion, and a tapered portion positioned between and connecting the base portion and the tip portion. A cooling channel is formed internal to the electrode to convey a flow of cooling fluid therethrough. The cooling channel includes at least one channel turn portion where the cooling channel turns 180 degrees between a channel inlet and a channel outlet. A post-forming heat treatment of the electrode is performed including a hot isostatic pressing process, a solid solution annealing process, and an age hardening process.

In addition to one or more of the features described herein, the electrode is formed from a copper material by one or more additive manufacturing processes.

In addition to one or more of the features described herein, the hot isostatic pressing process is performed at 950 degrees Celsius for two hours.

In addition to one or more of the features described herein, the solid solution annealing process is performed in an argon atmosphere at 980 degrees Celsius for 30 minutes.

In addition to one or more of the features described herein, the age hardening process is performed at 500 degrees Celsius for 3 hours.

In addition to one or more of the features described herein, a length of the cooling channel from the channel inlet to the channel turn portion is in a range of 5 to 15 millimeters.

In addition to one or more of the features described herein, a radius of curvature of the channel turn portion is in the range of 5 to 15 millimeters.

In yet another exemplary embodiment, a resistance spot welding apparatus includes two opposing arms, and an electrode positioned at an arm tip of each of the two opposing arms. At least one electrode includes a base portion, a tip portion, and a tapered portion positioned between and connecting the base portion and the tip portion. A cooling channel is formed internal to the electrode to convey a flow of cooling fluid therethrough. The cooling channel includes at least one channel turn portion where the cooling channel turns 180 degrees between a channel inlet and a channel outlet.

In addition to one or more of the features described herein, the electrode includes a base recess formed in the base portion, and the channel inlet and the channel outlet are formed in a recess wall of the base recess.

In addition to one or more of the features described herein, a first channel portion of the cooling channel extends from the channel inlet to the channel turn portion, and at least one second channel portion extends from the channel turn portion to one or more channel outlets.

In addition to one or more of the features described herein, a length of the cooling channel from the channel inlet to the channel turn portion is in a range of 5 to 15 millimeters.

In addition to one or more of the features described herein, a radius of curvature of the channel turn portion is in a range of 5 to 15 millimeters.

In addition to one or more of the features described herein, a diameter of the cooling channel is in a range of 1 to 2.5 millimeters.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of an exemplary embodiment of a vehicle;

FIG. 2 is a perspective view of an embodiment of a spot welded joint of a vehicle body;

FIG. 3 is a cross-sectional view of an embodiment of a spot welded joint of a vehicle body taken at line 3-3 of FIG. 2;

FIG. 4. is a cross-sectional view of an exemplary embodiment of an electrode of a spot welding apparatus;

FIG. 5 is a cross-sectional view of another exemplary embodiment of an electrode of a spot welding apparatus; and

FIG. 6 is an illustration of an embodiment of a method of forming an electrode.

### DETAILED DESCRIPTION

The following description is merely exemplary in nature and is not intended to limit the present disclosure, its application or uses. It should be understood that throughout the drawings, corresponding reference numerals indicate like or corresponding parts and features.

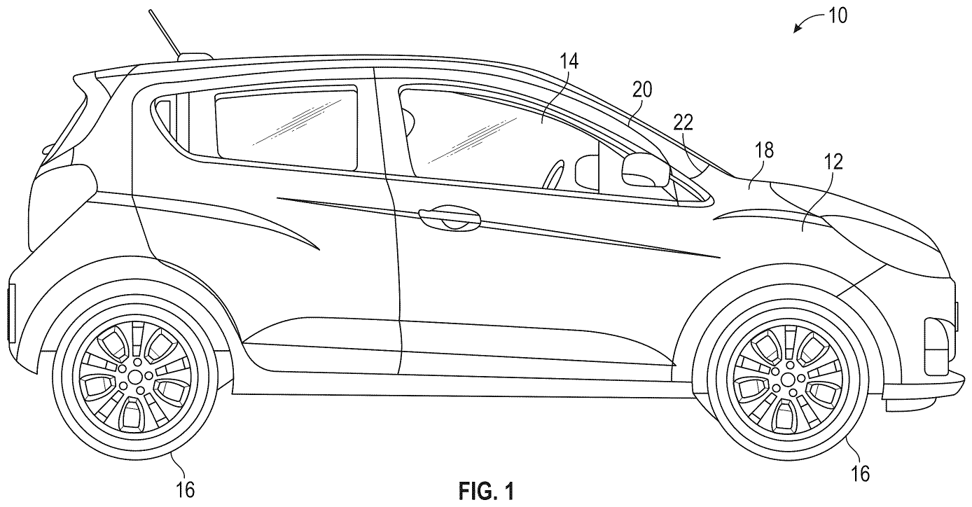

In accordance with an exemplary embodiment, a vehicle 10 is illustrated in FIG. 1. The vehicle 10 includes a vehicle body 12 defining an occupant compartment 14. The vehicle 10 is supported and moved be a plurality of wheels 16, which are driven be a propulsion system (not shown). The vehicle body 12 is formed from a plurality of body panels, for example, first body panel 18 and second body panel 20 that are joined at one or more panel joints, such as panel joint 22.

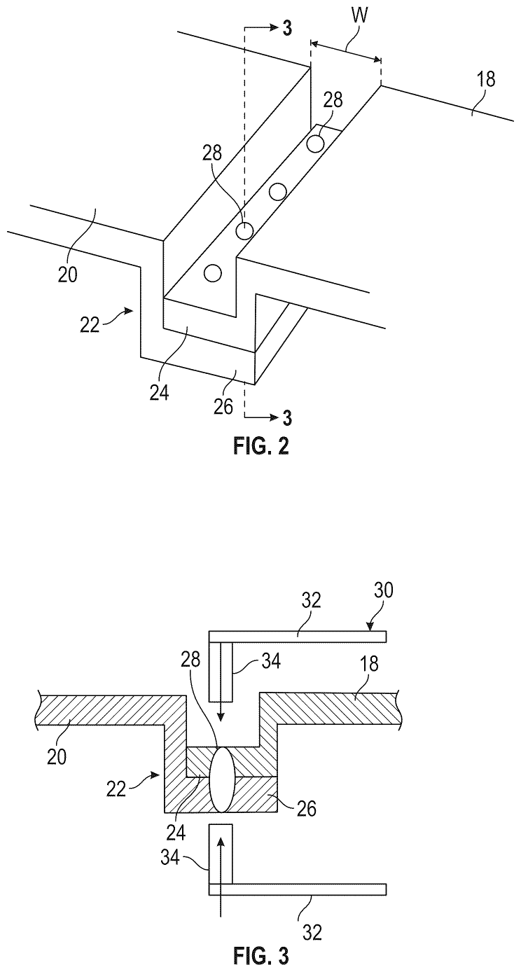

Referring now to FIG. 2, first body panel 18 includes a first panel flange 24 and second body panel 20 includes a second panel flange 26. The first panel flange 24 and the second panel flange 26 at least partially overlap, and the first panel flange 24 is secured to the second panel flange 26 by a plurality of spot welds 28 to define the panel joint 22. One skilled in the art will readily appreciate that the panel joint 22 configuration illustrated in FIG. 2 is merely exemplary, and that other shapes, sizes and configurations of panel joints 22 would benefit from the present disclosure.

Referring now to FIG. 3, the spot welds 28 are achieved utilizing a spot welder 30, including two opposing arms 32, which each terminate in an electrode 34. The spot welder 30 applies pressure at the panel joint urging the panel flanges 24 and 26 together, and also directs an electrical current to the panel joint 22 at the location of the electrodes 34, which melts the metal of the first panel flange 24 and the second panel flange 26, forming the spot weld 28. As it is desired to reduce a width “W” of the panel flanges 24 and 26, the size of the electrodes 34 must be similarly reduced, in order for the electrode 34 to fit at the reduced flange space. Additionally, the electrode 34 is internally cooled to reduce degradation of the electrode 34.

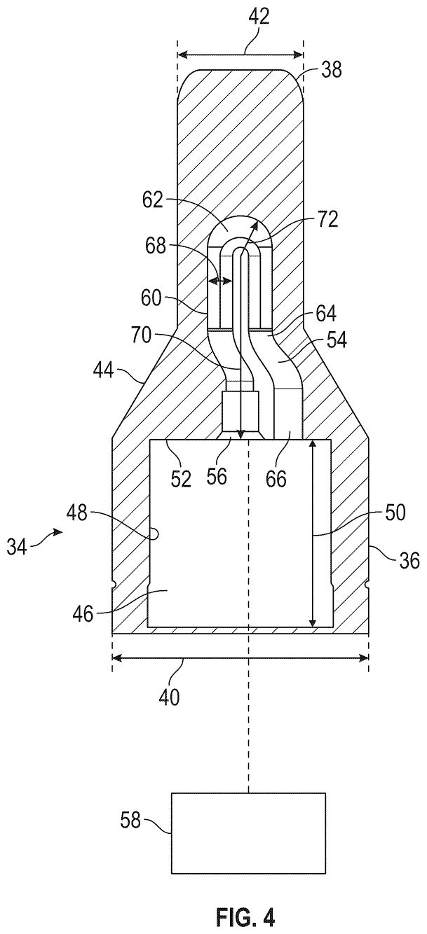

Referring now to FIG. 4, illustrated is a cross-sectional view of an embodiment of an electrode 34. The electrode 34 is formed from, for example, copper or a copper alloy, and extends from an electrode base 36 which is configured to connect to an arm 32, shown in FIG. 3, of the spot welder 30, to an electrode tip 38 which is configured to contact one of the flanges 24, 26 to produce the spot weld 28. In some embodiments, the electrode base 36 is cylindrical having a base outer diameter 40. The electrode tip 38 is similarly cylindrical having a tip outer diameter 42 which is less than the base outer diameter 40. Between the cylindrical electrode base 36 and the cylindrical electrode tip 38, the electrode 34 includes a transition portion 44 that radially tapers from the electrode base 36 to the electrode tip 38. The electrode base 36 is hollow, having a base recess 46 defined by a base inner radial wall 48. In some embodiments, the base recess 46 is further defined to a recess depth 50 by a recess wall 52.

To cool the electrode tip 38, the electrode 34 includes one or more cooling channels 54 formed in an interior of the transition portion 44 and the electrode tip 38. In the embodiment of FIG. 4, the electrode 34 includes a single cooling channel 54 that includes a channel inlet 56 at the recess wall 52 that is connected to a coolant source 58, such as a reservoir or the like. The cooling channel 54 includes a first channel portion 60 extending from the channel inlet 56 toward the electrode tip 38, a turn portion 62 connected to the first channel portion 60 at which the cooling channel 54 is turned 180 degrees away from the electrode tip 38 and towards the recess wall 52. A second channel portion 64 of the cooling channel 54 is connected to the turn portion 60 and extends to a channel outlet 66 at the recess wall 52. In some embodiments, the cooling channel 54 has a constant channel diameter 68 from the channel inlet 56 to the channel outlet 66, which may be in the range of 1.0-2.0 millimeters. In one embodiment the channel diameter is 1.5 millimeters. In other embodiments, the channel diameter 68 may vary along the cooling channel 54. In some embodiments, a channel depth 70 from the channel inlet 56 to a tip of the turn portion 62 is in the range of 5 millimeters to 15 millimeters, depending on cooling needs of the electrode 34. In one embodiment the channel depth 70 is 10 millimeters. In some embodiments, the turn portion 62 has a radius of curvature 72 in the range of 7-12 millimeters to facilitate smooth cooling fluid flow through the turn portion 62. In one embodiment, the radius of curvature 72 is 10 millimeters.

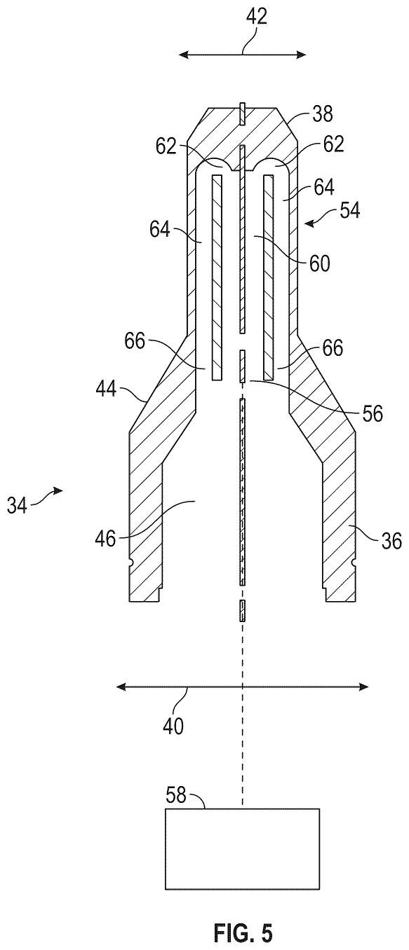

In other embodiments, as illustrated in FIG. 5, the cooling channel 54 has a single channel inlet 56 and a single first channel portion 60, but splits and includes two or more turn portions 62 and a corresponding two or more second channel portions 64 and channel outlets 66. In this embodiment, to allow for increased cooling fluid flow the first channel portion 60 is larger in channel diameter 68, for example, in the range of 1.5-2.5 millimeters and in one embodiment 2.0 millimeters.

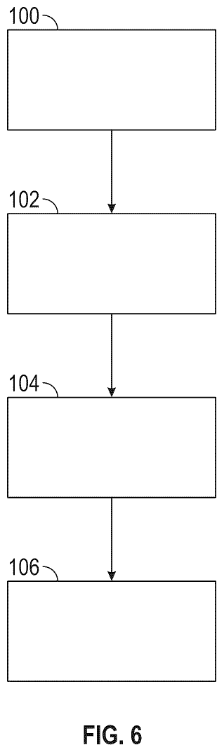

In some embodiments, the electrode 34 and the cooling channels 54 are produced from a copper material via one or more additive manufacturing processes, such as 3-D printing or the like. To ensure that the additively manufactured electrode 34 has the required mechanical and electrical properties to be utilized in resistance spot welding applications, the electrodes 34 are subjected to post-forming heat treatment operations as illustrated in FIG. 6. At step 100, the electrodes 34 are formed, including the cooling channels 54, via one or more additive manufacturing processes. After forming, the electrodes 34 are processed via one or more heat treatment operations. One exemplary process is illustrated in FIG. 6 and described herein. One skilled in the art will readily appreciate that other processes may be utilized to achieve desired structural properties of the electrodes. At step 102 the electrodes 34 are subjected to a hot isostatic pressing operation at, for example, 950 degrees Celsius for two hours. After the hot isostatic pressing operation, the electrodes 34 undergo solid solution annealing at step 104. The solid solution annealing is performed in an argon atmosphere at, for example, 980 degrees Celsius for 30 minutes. After the solid solution annealing process, at step 106 the electrodes 34 are age hardened at, for example, 500 degrees Celsius for 3 hours. This post-forming heat treatment processing ensures that the additively manufactured electrodes 34 have sufficient electrical and mechanical properties to be utilized in welding applications.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrode of a resistance spot welding apparatus, comprising:
a base portion;
a tip portion;
a tapered portion disposed between and connecting the base portion and the tip portion; and
a cooling channel formed internal to the electrode to convey a flow of cooling fluid therethrough, the cooling channel including at least one channel turn portion where the cooling channel turns 180 degrees between a channel inlet and a channel outlet.

2. The electrode of claim 1, wherein:
the electrode includes a base recess formed in the base portion; and
the channel inlet and the channel outlet are formed in a recess wall of the base recess.

3. The electrode of claim 1, further comprising:
a first channel portion of the cooling channel extending from the channel inlet to the channel turn portion; and
at least one second channel portion extending from the channel turn portion to one or more channel outlets.

4. The electrode of claim 1, wherein a length of the cooling channel from the channel inlet to the channel turn portion is in a range of 5 to 15 millimeters.

5. The electrode of claim 1, wherein a radius of curvature of the channel turn portion is in a range of 5 to 15 millimeters.

6. The electrode of claim 1, wherein a diameter of the cooling channel is in a range of 1 to 2.5 millimeters.

7. The electrode of claim 1, wherein the electrode is formed from a cooper material via one or more additive manufacturing processes and a post-forming heat treatment.

8. A method of producing an electrode of a resistance spot welding apparatus, comprising:
forming an electrode including:
a base portion;
a tip portion;
a tapered portion disposed between and connecting the base portion and the tip portion; and
a cooling channel formed internal to the electrode to convey a flow of cooling fluid therethrough, the cooling channel including at least one channel turn portion where the cooling channel turns 180 degrees between a channel inlet and a channel outlet; and
performing post-forming heat treatment of the electrode, including:
a hot isostatic pressing process;
a solid solution annealing process; and
an age hardening process.

9. The method of claim 8, wherein the electrode is formed from a copper material by one or more additive manufacturing processes.

10. The method of claim 8, wherein the hot isostatic pressing process is performed at 950 degrees Celsius for two hours.

11. The method of claim 8, wherein the solid solution annealing process is performed in an argon atmosphere at 980 degrees Celsius for 30 minutes.

12. The method of claim 8, wherein the age hardening process is performed at 500 degrees Celsius for 3 hours.

13. The method of claim 8, wherein a length of the cooling channel from the channel inlet to the channel turn portion is in a range of 5 to 15 millimeters.

14. The method of claim 8, wherein a radius of curvature of the channel turn portion is in the range of 5 to 15 millimeters.

15. A resistance spot welding apparatus including:
two opposing arms; and
an electrode disposed at an arm tip of each of the two opposing arms, at least one electrode including:
a base portion;
a tip portion;
a tapered portion disposed between and connecting the base portion and the tip portion; and
a cooling channel formed internal to the electrode to convey a flow of cooling fluid therethrough, the cooling channel including at least one channel turn portion where the cooling channel turns 180 degrees between a channel inlet and a channel outlet.

16. The apparatus of claim 15, wherein:
the electrode includes a base recess formed in the base portion; and
the channel inlet and the channel outlet are formed in a recess wall of the base recess.

17. The apparatus of claim 15, further comprising:
a first channel portion of the cooling channel extending from the channel inlet to the channel turn portion; and
at least one second channel portion extending from the channel turn portion to one or more channel outlets.

18. The apparatus of claim 15, wherein a length of the cooling channel from the channel inlet to the channel turn portion is in a range of 5 to 15 millimeters.

19. The apparatus of claim 15, wherein a radius of curvature of the channel turn portion is in a range of 5 to 15 millimeters.

20. The apparatus of claim 15, wherein a diameter of the cooling channel is in a range of 1 to 2.5 millimeters.
